(19) United States
(12) Patent Application Publication
(10) Pub. No.: US 2007/0291348 A1
(43) Pub. Date: Dec. 20, 2007

(54) Tracing Method and Apparatus

(76) Inventors: Teppei Ejiri, Kanagawa-ken (JP); Takao Ozaki, Kanagawa-ken (JP); Yoji Okazaki, Kanagawa-ken (JP)

Correspondence Address: SUGHRUE MION, PLLC, 2100 PENNSYLVANIA AVENUE, N.W., SUITE 800, WASHINGTON, DC, 20037, US

(21) Appl. No.: 11/665,478

(22) PCT Filed: Oct. 13, 2005
(86) PCT No.: PCT/JP05/19258

§ 371 Date: Apr. 16, 2007

(30) Foreign Application Priority Data
Oct. 15, 2004 (JP) 302284/2004

(51) Int. Cl. G02B 26/10

(52) U.S. Cl. 359/298

(57) ABSTRACT

In a tracing method in which tracing is performed by moving a plurality of tracing heads, each including a spatial optical modulation device and an optics system, in a predetermined direction relative to a tracing surface, changes in the relative positional relationship of the tracing heads arising from changes in the environmental temperature are minimized. A plurality of spatial optical modulation devices 34a, 34b are provided in a single tracing head 30, and the light modulated by the plurality of spatial optical modulation devices 34a, 34b is focused on a tracing surface 12a using common optics systems 36, 37 and 38 to reduce the number of the heads 30.

### TECHNICAL FIELD

The present invention relates to a tracing method and apparatus for performing tracing by moving a tracing head in a predetermined scanning direction relative to a tracing surface, the tracing head including a spatial optical modulation device constituted by multitudes of tracing elements for modulating inputted light according to control signals transferred in accordance with tracing information.

### BACKGROUND ART

Various types of tracing devices for forming an intended two-dimensional pattern represented by image data on a tracing surface are known.

As such kind of tracing devices, various types of photolithography machines for performing photolithography by modulating a light beam according to image data using a spatial modulation device, such as a digital micro-mirror device (hereinafter referred to as “DMD”) or the like are proposed. DMD is constituted by multitudes of tiny micro-mirrors arranged two-dimensionally (L rows×M columns) on memory cells (SRAM arrays) formed on a semiconductor substrate made of, for example, silicon or the like, and the angle of the reflection surface of the mirror may be changed by tilting the mirror through controlling electrostatic force provided by the charges stored in the memory cell. The photolithography is performed by scanning the DMD in a predetermined direction along the exposing surface.

Here, the photolithography machine described above includes a plurality of exposing heads disposed in the scanning direction and a direction which is orthogonal to the scanning direction, and each of the exposing heads includes a single DMD and a focusing optics system for focusing light modulated by the DMD on the exposing surface as described, for example, in Japanese Unexamined Patent Publication No. 2004-233718. By forming linear head arrays in the manner as described above and performing photolithography, the time required for the photolithography may be reduced.

But, forming linear head arrays requires many exposing heads, and the relative positions between many exposing heads may vary due to, for example, thermal expansion of the member supporting the heads arising from changes in the environmental temperature or the like. In the photolithography machine described above, the supporting member described above is made of a composite material of glass and metal and relatively large, so that the influence of the thermal expansion is of a particular concern.

Further, where many exposing heads are used as described above, alignment work for aligning the relative positions of the exposing heads is time consuming and requires high costs.

In addition, a great many optical components are required, resulting in higher costs.

In view of the circumstances described above, it is an object of the present invention to provide a tracing method and apparatus capable of minimizing changes in the relative positional relationship of the tracing heads arising from changes in the environmental temperature, and simplifying the tracing head alignment work with reduced costs.

### DISCLOSURE OF INVENTION

The tracing method of the present invention is a tracing method using a tracing head that includes a spatial optical modulation device constituted by multitudes of tracing elements disposed thereon two-dimensionally for modulating inputted light according to control signals transferred in accordance with tracing information, and an optics system for focusing the light modulated by the spatial optical modulation device on a tracing surface, in which tracing is performed by implementing the modulation through transferring the control signals to the tracing elements of the spatial optical modulation device, and moving the tracing head in a predetermined scanning direction relative to the tracing surface, wherein:

the tracing head includes a plurality of the spatial optical modulation devices and a common optics system for focusing the light modulated by the plurality of spatial optical modulation devices on the tracing surface; and

the method uses the tracing head that includes the plurality of spatial optical modulation devices and the common optics system to perform the tracing.

In the tracing method described above, the plurality of spatial optical modulation devices and the optics system of the tracing head may be disposed such that the regions of the tracing surface on which the light modulated by the plurality of spatial optical modulation devices is focused by the optics system are arranged side by side in the scanning direction and/or a direction which is orthogonal to the scanning direction.

Further, the control signals may be transferred to the plurality of spatial optical modulation devices in parallel or independently.

Still further, arrangement of each of trace regions on the tracing surface corresponding to each of the spatial optical modulation devices may be controlled by causing the modulation to be implemented independently by each of the spatial optical modulation devices, and controlling the timing of the modulation implemented independently by each of the spatial optical modulation devices, and/or the relative moving speed of the tracing head in the scanning direction.

Further, each of the plurality of spatial optical modulation devices may be divided into a plurality of blocks, and the control signals may be transferred to each of the plurality of blocks in each of the spatial optical modulation devices in parallel or independently.

Still further, each of the blocks in each of the spatial optical modulation devices may be further subdivide into a plurality of segments, and the control signals may be transferred sequentially to each of the plurality of segments, and the modulation is implemented sequentially when each of the transfers of the control signals is completed in each of the blocks in each of the spatial optical modulation devices.

Further, each of the plurality of spatial optical modulation devices may be divided into a plurality of blocks in the scanning direction, and the control signals may be transferred to each of the blocks in each of the spatial optical modulation devices in parallel or independently.

Still Further, the arrangement of each of block trace regions on the tracing surface corresponding to each of the blocks in each of the spatial optical modulation devices may be controlled by causing the modulation to be implemented independently by each of the blocks in each of the spatial optical modulation devices, and controlling the timing of the modulation implemented independently by each of the blocks in each of the spatial optical modulation devices, and/or the relative moving speed of the tracing head in the scanning direction.

Further, each of the blocks in each of the spatial optical modulation devices may be further subdivided into a plurality of segments in the scanning direction, and the control signals may be transferred sequentially to each of the plurality of segments, and the modulation may be implemented sequentially when each of the transfers of the control signals is completed in each of the blocks in each of the spatial optical modulation devices.

Still Further, the arrangement of each of segment trace regions on the tracing surface corresponding to each of the segments in each of the blocks in each of the spatial optical modulation devices is controlled by controlling the timing of the modulation implemented by each of the segments in each of the blocks in each of the spatial optical modulation devices, and/or the relative moving speed of the tracing head in the scanning direction.

The tracing apparatus of the present invention is a tracing apparatus comprising:

a tracing head including a spatial optical modulation device constituted by multitudes of tracing elements disposed thereon two-dimensionally for modulating inputted light according to control signals transferred in accordance with tracing information, and an optics system for focusing the light modulated by the spatial optical modulation device on a tracing surface;

a moving means for moving the tracing head in a predetermined scanning direction relative to the tracing surface; and

a control means for causing the tracing elements of the spatial optical modulation device to implement the modulation by transferring the control signals thereto, and controlling the relative moving speed of the tracing head in the scanning direction through controlling the moving means,

wherein the tracing head includes a plurality of the spatial optical modulation devices and a common optics system for focusing the light modulated by the plurality of spatial optical modulation devices on the tracing surface.

In the tracing apparatus described above, the plurality of spatial optical modulation devices and the optics system of the tracing head may be disposed such that the regions of the tracing surface on which the light modulated by the plurality of spatial optical modulation devices is focused by the optics system are arranged side by side in the scanning direction and/or a direction which is orthogonal to the scanning direction.

Further, the control means may include a plurality of control signal transfer sections, each being provided for each of the plurality of spatial optical modulation devices, for transferring the control signals to the plurality of spatial optical modulation devices in parallel or independently.

Still further, the control section may be configured to control the arrangement of each of trace regions on the tracing surface corresponding to each of the spatial optical modulation devices by causing the modulation to be implemented independently by each of the spatial optical modulation devices, and controlling the timing of the modulation implemented independently by each of the spatial optical modulation devices, and/or the relative moving speed of the tracing head in the scanning direction.

Further, each of the plurality of spatial optical modulation devices may be divided into a plurality of blocks, and the control means may include a plurality of block control signal transfer sections, each being provided for each of the plurality of blocks in each of the spatial optical modulation devices, for transferring the control signals to each of the blocks in each of the spatial optical modulation devices in parallel or independently.

Still further, each of the blocks in each of the spatial optical modulation devices may be further subdivide into a plurality of segments, and the control means may be configured to sequentially transfer the control signals to each of the segments and to cause the modulation to be implemented sequentially when each of the transfers of the control signals is completed in each of the blocks in each of the spatial optical modulation devices.

Further, each of the plurality of spatial optical modulation devices may be divided into a plurality of blocks in the scanning direction, and the control means may include a plurality of block control signal transfer sections, each being provided for each of the blocks in each of the spatial optical modulation devices, for transferring the control signals to each of the blocks in each of the spatial optical modulation devices in parallel or independently.

Still further, the control section may be configured to control the arrangement of each of block trace regions on the tracing surface corresponding to each of the blocks in each of the spatial optical modulation devices by causing the modulation to be implemented independently by each of the blocks in each of the spatial optical modulation devices, and controlling the timing of the modulation implemented independently by each of the blocks in each of the spatial optical modulation devices, and/or the relative moving speed of the tracing head in the scanning direction.

Further, each of the blocks in each of the spatial optical modulation devices may be further subdivided into a plurality of segments in the scanning direction, and the control section may be configured to sequentially transfer the control signals to each of the segments and to cause the modulation to be implemented sequentially when each of the transfers of the control signals is completed in each of the blocks in each of the spatial optical modulation devices.

Still further, the control means may be configured to control the arrangement of each of segment trace regions on the tracing surface corresponding to each of the segments in each of the blocks in each of the spatial optical modulation devices by controlling the timing of the modulation implemented by each of the segments in each of the blocks in each of the spatial optical modulation devices, and/or the relative moving speed of the tracing head in the scanning direction.

Here, the referent of “common optics system” means an optics system for focusing the light modulated by the plurality of spatial optical modulation devices, and may be adjusted as a unit.

Further, the referent of “transfer the control signals in parallel” as used herein means that the control signals are transferred simultaneously at least at a predetermined time point, and may include the case where there is a predetermined time difference between the start timings of transferring the control signals, as well as the case where the control signals are transferred at the same start timing.

Still further, the referent of “divided in the scanning direction” as used herein means that where either of the two orthogonal directions to which the tracing elements are disposed corresponds to the scanning direction, the division is made in that direction, and where neither of the two orthogonal directions corresponds to the scanning direction, the division is made in the direction that forms a smaller tilt angle with the scanning direction.

According to the tracing method and apparatus of the present invention, tracing is performed using a tracing head that includes a plurality of spatial optical modulation devices, and a common optics system for focusing the light modulated by the plurality of spatial optical modulation devices on a tracing surface. This may reduce the number of tracing heads and adjusting points for head alignment. Consequently, variations in the relative positional relationship of the tracing heads arising from changes in the environmental temperature may be reduced. This may result in simplified head aligning work and cost reductions.

Further, reduced number of adjusting points for head alignment allows minimized variation in the adjustment accuracy and improved positional accuracy of the heads. Where there are N adjusting points, the variation is generally expressed as \sqrt{n}. Accordingly, if the number of adjusting points are reduced ½, then the variation becomes 0.7.

Still further, compared with the case where an individual optics system is used for an individual spatial optical modulation device to construct a tracing head, more integrated components may be employed. This makes the tracing head superior in both weight and robustness, that is, the tracing head with less degradation in accuracy arising from flexures and vibrations may be constructed.

Further, the number of tracing heads may be reduced, which reduces the number of pixel aligning points between the tracing heads. That is, the number of factors that degrade the positional accuracy may be reduced.

Still further, in assembling the tracing head, the use of a single common optics system for a plurality of spatial optical modulation devices results in shorter time and reduced costs for adjusting the positions of the spatial optical modulation devices and optics system compared with the case where an individual optics system is used for an individual spatial optical modulation device.

Further, if each of the trace regions exposed by each of a plurality of tracing heads is arranged to overlap with each other, the number of power gradations may be readily increased. For example, when two spatial optical modulation devices are used, and 0.65 W light is inputted to one of the spatial optical modulation devices, and 0.35 W light is inputted to the other, four different gradations of 0 W, 0.65 W, 0.135 W and 2 W may be obtained in tracing. If 1 W light is inputted to the two spatial optical modulation devices respectively, then three different gradations of 0 W, 1 W and 2 W may be obtained in tracing.

In the tracing method and apparatus described above, when each of the plurality of spatial optical modulation devices is divided into a plurality of blocks, and control signals are transferred to each of the blocks in parallel in each of the spatial optical modulation devices, then the modulation speed may be enhanced compared with the case, for example, where image data are sequentially transferred to the SRAM arrays and written therein on a row by row basis, and resetting is performed after image data for all of the rows are transferred to the SRAM arrays. For example, if the spatial optical modulation device is divided into four blocks, the modulation speed may be quadrupled.

Further, when the arrangement of each of block trace regions on the tracing surface corresponding to each of the blocks in each of the spatial optical modulation devices is controlled by causing the modulation to be implemented independently by each of the blocks in each of the spatial optical modulation devices, and controlling the timing of the modulation implemented independently by each of the blocks in each of the spatial optical modulation devices, and/or the relative moving speed of the tracing head in the scanning direction, the arrangement of each of the trace regions on the tracing surface corresponding to each of the blocks may be controlled at will. For example, trace points in each of the trace regions corresponding to each of the blocks may be arranged evenly spaced apart in the scanning direction, which results in uniformly distributed resolution.

Further, when each of the blocks in each of the spatial optical modulation devices is further subdivided into a plurality of segments in the scanning direction, and the control signals are transferred sequentially to each of the plurality of segments, and the modulation is implemented sequentially when each of the transfers of the control signals is completed in each of the blocks in each of the spatial optical modulation devices, then, while one of the segments is being reset, control signal transfers to other segments may be implemented in each of the blocks. This allows the modulation speed of each of the blocks to be further enhanced. Further, during the modulation time of each of the blocks, trace points of each of the segments may be traced, so that the resolution may be improved. For example, when each of the blocks is subdivided into three segments, the resolution may be tripled.

### BRIEF DESCRIPTION OF DRAWINGS

FIG. 1 is a perspective view of a photolithography machine that employs a first embodiment of the tracing apparatus of the present invention, illustrating the appearance thereof.

FIG. 2 is a perspective view of a scanner used in the photolithography machine shown in FIG. 1, illustrating the configuration thereof.

FIG. 3 is a schematic configuration diagram of the exposing head shown in FIG. 2.

FIG. 4 is a partial enlarged view of a DMD used in the photolithography machine shown in FIG. 1, illustrating the configuration thereof.

FIG. 5A is a perspective view of a DMD, illustrating the operation thereof.

FIG. 5B is a perspective view of a DMD, illustrating the operation thereof.

FIG. 6 is a drawing illustrating blocks on a DMD.

FIG. 7 is a schematic block diagram of control signal transfer sections, each provided for each of the blocks.

FIG. 8 is a timing chart, illustrating a first embodiment of the photolithography method using the photolithography machine shown in FIG. 1.

FIG. 9 is a timing chart, illustrating a second embodiment of the photolithography method using the photolithography machine shown in FIG. 1.

FIG. 10 is a timing chart, illustrating a third embodiment of the photolithography method using the photolithography machine shown in FIG. 1.

FIG. 11 is a timing chart, illustrating a fourth embodiment of the photolithography method using the photolithography machine shown in FIG. 1.

FIG. 12 is a timing chart, illustrating a fifth embodiment of the photolithography method using the photolithography machine shown in FIG. 1.

FIG. 13 is a timing chart, illustrating a sixth embodiment of the photolithography method using the photolithography machine shown in FIG. 1.

FIG. 14 is a timing chart, illustrating a modified example of a first embodiment of the photolithography method using the photolithography machine shown in FIG. 1.

FIG. 15 is a timing chart, illustrating a modified example of a second embodiment of the photolithography method using the photolithography machine shown in FIG. 1.

FIG. 16 is a timing chart, illustrating a modified example of a third embodiment of the photolithography method using the photolithography machine shown in FIG. 1.

FIG. 17 is a timing chart, illustrating a modified example of a fourth embodiment of the photolithography method using the photolithography machine shown in FIG. 1.

FIG. 18 is a timing chart, illustrating a modified example of a fifth embodiment of the photolithography method using the photolithography machine shown in FIG. 1.

FIG. 19 is a timing chart, illustrating a modified example of a sixth embodiment of the photolithography method using the photolithography machine shown in FIG. 1.

FIG. 20A is a drawing illustrating another embodiment of the exposing head.

FIG. 20B is a drawing illustrating another embodiment of the exposing head.

### BEST MODE FOR CARRYING OUT THE INVENTION

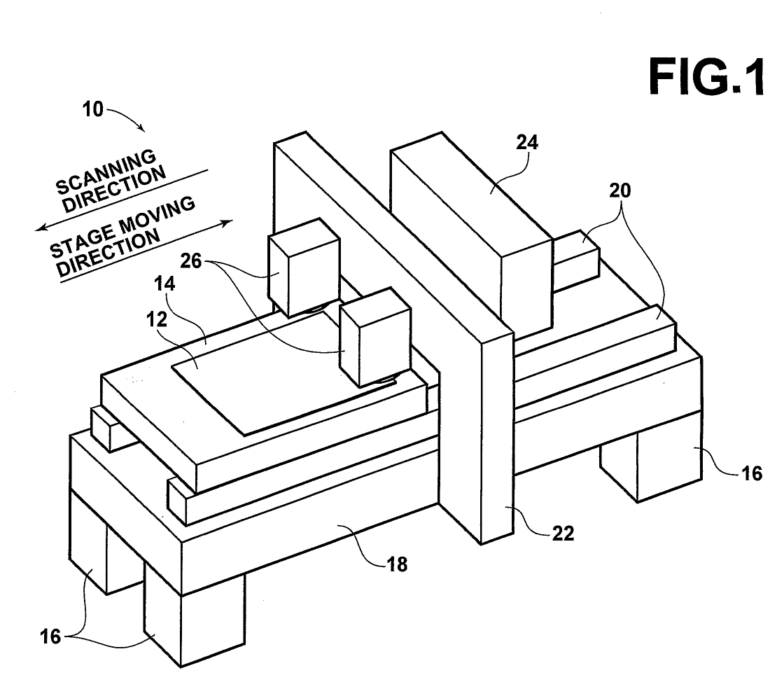

Hereinafter, a photolithography machine that employs a first embodiment of the tracing method and apparatus of the present invention will be described in detail with reference to accompanying drawings. FIG. 1 is a perspective view of the photolithography machine according to the present embodiment illustrating the schematic configuration thereof.

As shown in FIG. 1, the photolithography machine 10 of the present embodiment includes a plate-like moving stage 14 for holding a sheet-like photosensitive material 12 thereon by suction. Two guides 20 extending along the moving direction of the stage are provided on the upper surface of a thick plate-like mounting platform 18 which is supported by four legs 16. The stage 14 is arranged such that its longitudinal direction is oriented to the moving direction of the stage, and movably supported by the guides 20 to allow back-and-forth movements.

An inverse U-shaped gate 22 striding over the moving path of the stage 14 is provided at the central part of the mounting platform 18. Each of the ends of the inverse U-shaped gate 22 is fixedly attached to each of the sides of the mounting platform 18. A scanner 24 is provided on one side of the gate 20, and a plurality of sensors 26 (e.g. two) for detecting the front and rear edges of the photosensitive material 12 is provided on the other side. The scanner 24 and sensors 26 are fixedly attached to the gate 22 over the moving path of the stage 14. The scanner 24 and sensors 26 are connected to a control section that controls them, which will be described later.

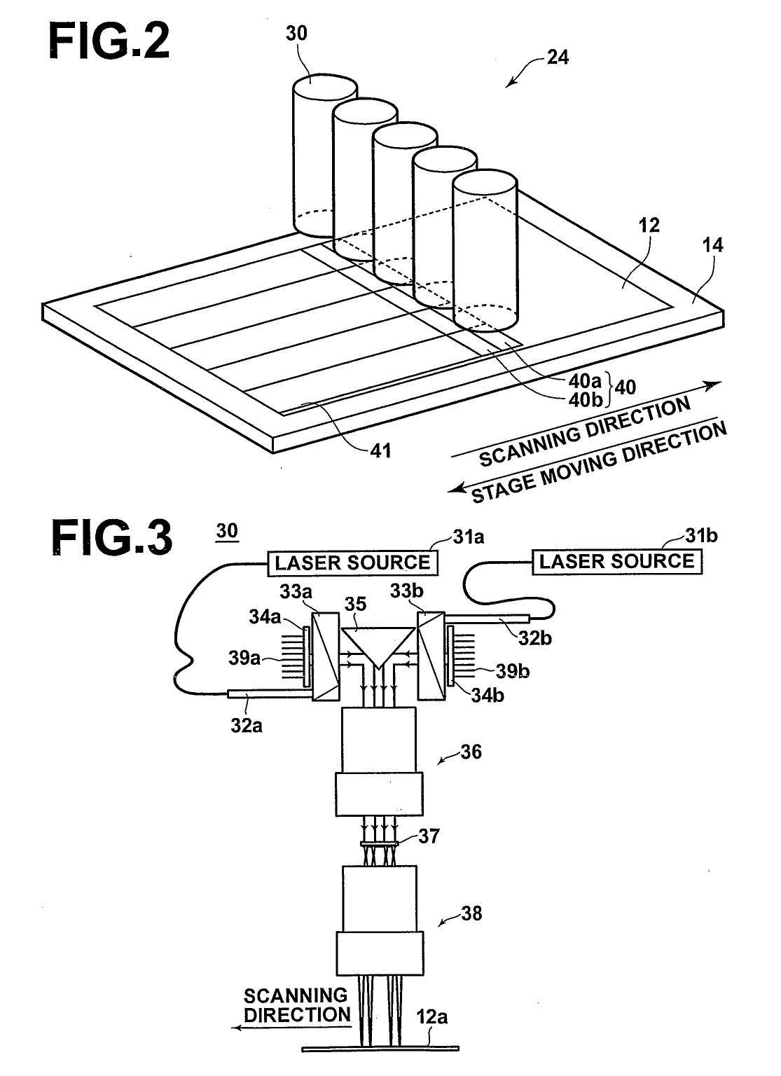

As shown in FIG. 2, the scanner 24 includes five exposing heads 30 disposed linearly in a direction which is orthogonal to the scanning direction.

FIG. 3 shows a schematic configuration of the exposing head 30. The exposing head 30 includes: two laser sources 31a, 31b for emitting laser beams; light guide members 32a, 32b for guiding the respective laser beams emitted from the respective laser sources 31a, 31b; first prisms 33a, 33b for inputting the respective light beams guided by the respective light guide members 32a, 32b to respective DMDs 34a, 34b, which will be described later. The exposing head 30 further includes: two DMDs 34a, 34b for modulating the respective laser beams focused by the respective first prisms 33a, 33b in accordance with control signals inputted therein; a second prism 35 for reflecting the light beams modulated by the respective DMDs 34a, 34b toward the exposing surface 12a; a first and second projector lenses 36, 38 for projecting the light beams reflected by the second prism 35 onto the exposing surface 12a; a micro-lens arrays 37 disposed between the first and second projector lenses; and cooling fins 39a, 39b for cooling the respective DMDs 34a, 34b attached thereto.

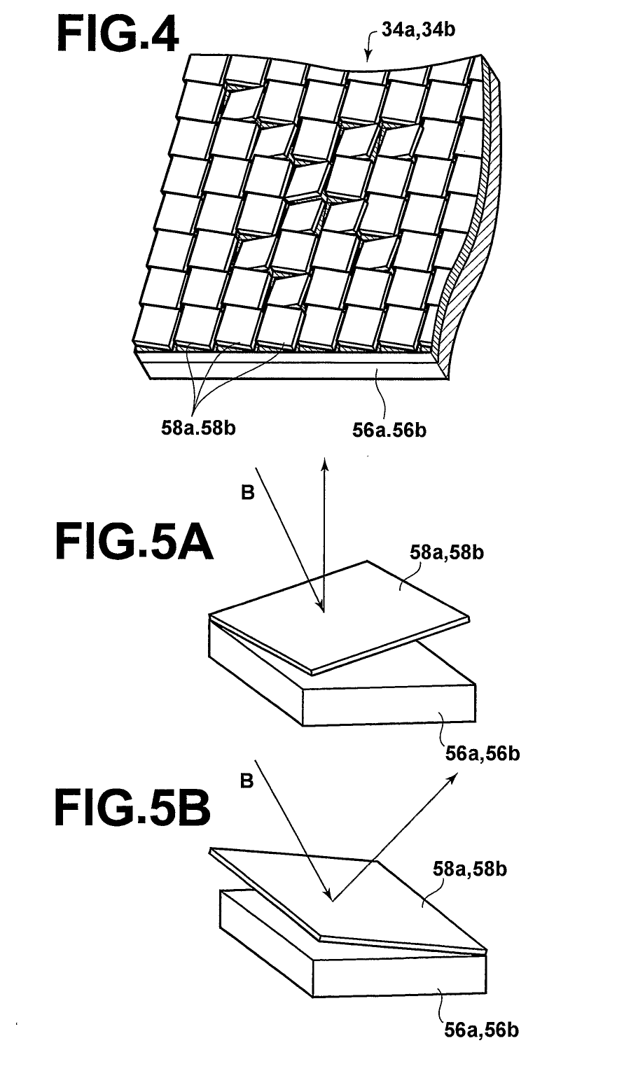

Each of the DMDs 34a, 34b includes micro-mirrors, which serve as tracing elements, disposed two dimensionally in orthogonal directions. The DMDs 34a, 34b include respective micro-mirrors 58a, 58b supported by support posts on the respective SRAM arrays (memory cells) 56a, 56b as shown in FIG. 4. The DMDs 34a, 34b are mirror devices constituted by a multitude (e.g., 13.68 μm pitch, 1024×768) of respective micro-mirrors 58a, 58b that form pixels are disposed two dimensionally in orthogonal directions. As described earlier, silicon-gate CMOS SRAM arrays 56a, 56b which may be produced by a manufacturing line for general semiconductor memories, are provided beneath the respective micro-mirrors 58a, 58b through the support posts, each of which includes a hinge and yoke.

When digital signals serving as control signals are written into the SRAM arrays 56a, 56b of the respective DMD 34a, 34b, a control voltage is applied to an electrode section (not shown) of each of the micro-mirrors 58a, 58b in accordance with the digital signal. Then, each of the micro-mirrors 58a, 58b supported by each of the support post is tilted within the range of ±α degrees (e.g., ±10 degrees) centered on the diagonal line by the electrostatic force developed by the applied voltage. FIG. 5A shows one of the micro-mirrors 58a, 58b tilted by +α degrees, which means that it is in on-state, and FIG. 5B shows one of the micro-mirrors 58a, 58b tilted by −α degrees, which means that it is in off-state. The light beam B inputted to one of the micro-mirrors 58a, 58b when it is in on-state is reflected toward the photosensitive material 12, and the light beam B inputted to one of the micro-mirrors 58a, 58b when it is in off-state is reflected toward a light absorption material other than the photosensitive material 12.

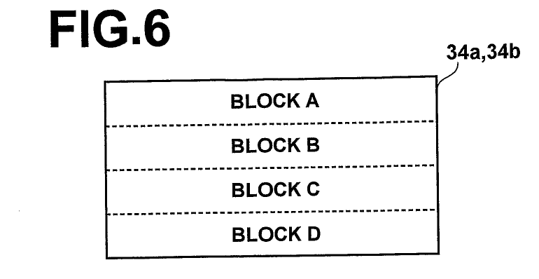

Here, each of the DMDs 34a, 34b of the photolithography machine of the present embodiment is divided into four blocks A to D, each including a plurality of micro-mirrors as shown in FIG. 6.

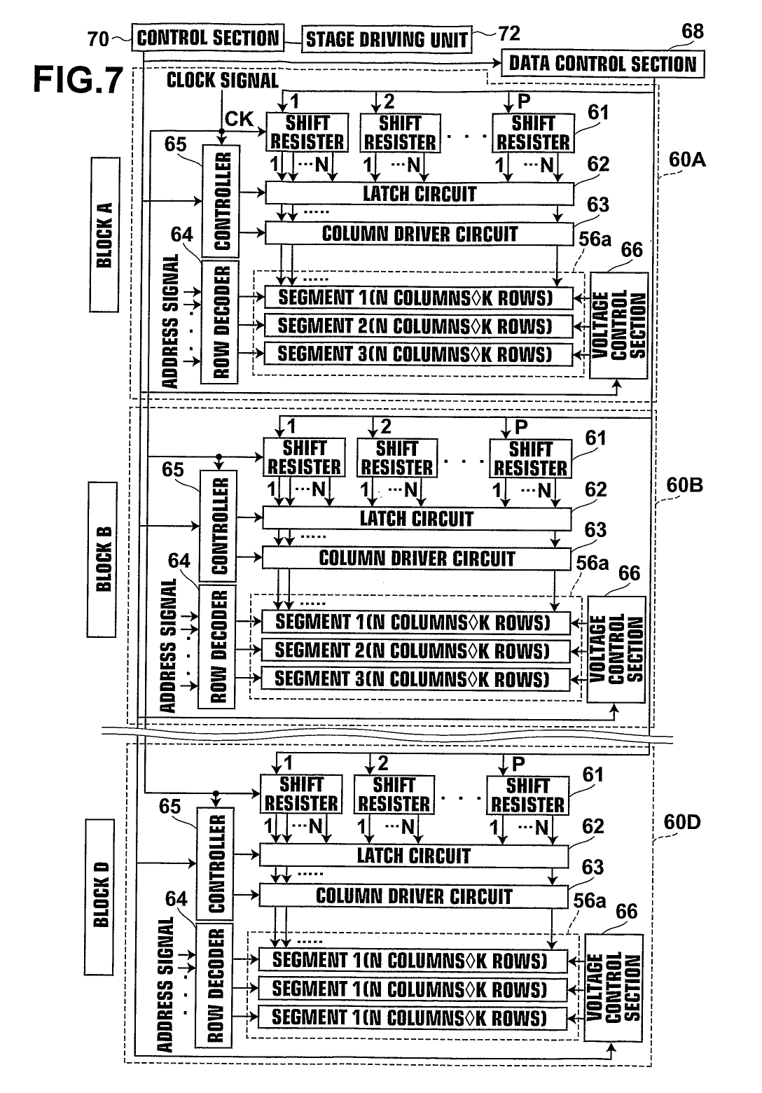

As shown in FIG. 7, each of the exposing heads 30 includes four control signal transfer sections 60A to 60D for the blocks A to D in each of the DMDs 34a, 34b. In FIG. 7, the control signal transfer section 60C is omitted. Further, in the present embodiment, each of the DMDs 34a, 34b is divided into four blocks, but it may be divided into any number of blocks of not less than two.

As described above, four control signal transfer sections 60A to 60D are provided for each of the DMDs 34a, 34b of each of the exposing heads 30. Hereinafter, however, the configuration of signal transfer sections for one of the DMDs 34a, 34b will be described. As shown in FIG. 7, each of the control signal transfer sections 60A to 60D includes P shift resister circuits 61, a latch circuit 62, and a column driver circuit 63. A clock signal CK is inputted to each of the P shift register circuits 61 from a controller 65. One control signal is written into each of the P shift register circuits 61 simultaneously according to the clock signal CK. When N control signals are written into each of the P shift register circuits 61, the control signals of NxP for a single row are transferred to the latch circuit 62.

The control signals of a single row transferred to the latch circuit 62 are transferred as they are to the column driver circuit 63. The control signals for a single row outputted from the column driver circuit 63 are written into a predetermined row of the SRAM arrays 56a. The predetermined row where the control signals are to be written is selected by a row decoder 64 based on an address signal.

While the control signals are latched by the latch circuit 62 and written into a predetermined row of the SRAM arrays 56a as described above, control signals for the next row are written into the shift register circuits 61.

The timings for writing the control signals into the shift register circuits 61, latch circuit 62, column driver circuit 63, and SRAM arrays 56a are controlled by the controller 65.

After the control signals are written into the SRAM arrays 56a, control voltages according to the control signals written into the SRAM arrays 56a are applied to the respective electrode sections of the micro-mirrors 58a from a voltage control section 66, thereby each of the micro-mirrors is reset.

The voltage control section 66 provided for each of the blocks A to D is capable of outputting the control voltage to each of the three segments 1 to 3 provided by dividing micro-mirror rows in every K rows in each of the blocks A to D. In the present embodiment, each of the blocks A to D is divided into three segments, but it may be divided into any number of segments of not less than two. Further, in the present embodiment, the voltage control section 66, which is in the mode of outputting the control voltage to each of the segments 1 to 3 simultaneously, will be described, and in other embodiments to be described later, the voltage control section 66, which is in the mode of outputting the control signal to each of the segments 1 to 3 independently, will be described.

The photolithography machine 10 of the present embodiment further includes a control section 70 for performing overall control of the photolithography machine, and a data control section 68 for outputting control signals to the control signal transfer sections 60A to 60D provided for each of the DMDs 34a, 34b. The writing operation of the control signals into the SRAM arrays 56a, 56b of the respective DMDs 34a, 34b of each of the exposing heads 30, and driving of the micro-mirrors 58a, 58b are controlled by the control section 70. The control section 70 further drive controls a stage driving unit 72 that moves the moving stage 14.

Hereinafter, the operation of the photolithography machine 10 of the present embodiment will be described in detail.

First, image data corresponding to an image to be exposed on the photosensitive material 12 are generated by a predetermined data generating device (not shown), which is outputted to the data control section 68. In the data control section 68, control signals to be outputted to each of the exposing heads 30 are generated based on the image data. In the photolithography machine 10 of the present embodiment, control signals are transferred to blocks A to D of each of the DMDs 34a, 34b to drive the micro-mirrors 58a, 58b on a block by block basis, so that the control signals are also generated on a block by block basis.

While the control signals for each of the exposing heads 30 are generated by the data control section 68, a stage drive control signal is outputted to the stage driving unit 72 from the control section 70. The stage driving unit 72 moves the moving stage 14 along the guides 20 in the stage moving direction at an intended speed according to the stage drive control signal. In the mean time, the laser sources 31a, 31b are driven by control signals from the control section 70, and laser beams are emitted therefrom. The laser beams emitted from the respective laser sources 31a, 31b are guided through the light respective guiding members 32a, 32b, and directed to the respective first prisms 33a, 33b, which are then directed to the respective DMDs 34a, 34b by the respective first prisms 33a, 33b.

When the stage 14 passes under the gate 22, the front edge of the photosensitive material 12 is detected by the sensors 26 attached to the gate 22. Then, the control signals are outputted to each of the exposing heads 30 from the data control section 68, and tracing is initiated by each of the exposing heads 30.

Hereinafter, drive control for the DMDs 34a, 34b of each of the exposing heads 30 will be described in detail.

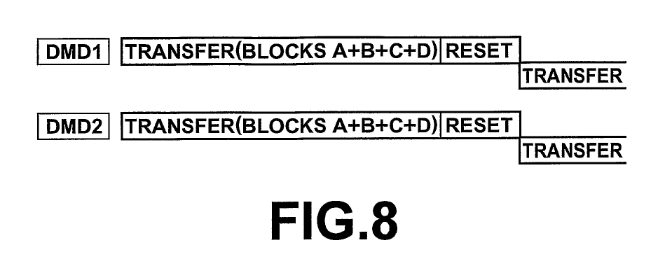

First, description will be provided for the case where each of the DMDs 34a, 34b is drive controlled by outputting the control signals sequentially to each of the blocks A to D in each of the DMDs 34a, 34b. FIG. 8 shows a timing chart when such drive control is implemented. In the timing chart shown in FIG. 8, DMD 34a and DMD 34b are designated as DMD 1 and DMD 2 respectively.

More specifically, control signals are first transferred to the block A in each of the DMD 34a, 34b, and then sequentially to block B, block C, and block D in each of the DMD 34a, 34b at the same timing.

The control signals transferred in the manner described above are written into the SRAM arrays 56a, 56b in each of the blocks A to D by each of the control signal transfer sections 60A to 60D provided for each of the blocks A to D.

As shown in FIG. 8, when the control signals are transferred to each of the blocks A to D in each of the DMDs 34a, 34b, control voltages according to the control signals written therein are applied from the voltage control section 66 and all the micro-mirrors 58a, 58b are reset.

Light beams modulated by the DMDs 34a, 34b through the resetting described above are directed to the second prism 35, which are then reflected by the second prism 35 toward the exposing surface 12a. The light beams reflected by the second prism 35 are focused on the exposing surface 12a by the first and second projector lenses 36, 38, and micro-lens arrays 37, forming rectangular exposing regions 40a, 40b respectively as shown in FIG. 2. Each of the micro-lenses constituting the micro-lens arrays 37 is disposed in a position corresponding to each of the micro-mirrors 58a, 58b in each of the DMDs 34a, 34b.

Then, the photosensitive material 12 moves with the moving stage 14 at a constant speed. The photosensitive material 12 is scanned by the scanner 24 in the direction opposite to the stage moving direction, and transfer of the control signals to the DMDs 34a, 34b and resetting thereof are repeated in the manner as described above at the timings shown in FIG. 8. In this way, a stripe-shaped exposed region 41 is formed by each of the exposing heads 30.

When the scanning of the photosensitive material 12 by the scanner 24 is completed, and rear edge of the photosensitive material 12 is detected by the sensors 26, the stage 14 is returned to the original position on the uppermost stream of the gate 22 by the stage driving unit 72 along the guides 20. Thereafter, the stage 14 is moved again along the guides 20 from the upstream to downstream of the gate 22 at a constant speed after a new photosensitive material 12 is placed thereon.

In the first embodiment, each of the control signal transfer sections 60A to 60D is provided for each of the blocks A to D in each of the DMDs 34a, 34b. Where the control signals are transferred in the manner as described above, however, the configuration is not necessarily limited to this. It may be such that a single control transfer section is provided for each of the DMDs 34a, 34b.

In the first embodiment, the exposing region 40a to be exposed by the DMD 34a and the exposing region 40b to be exposed by the DMD 34b are arranged without any spacing between them in the scanning direction as shown in FIG. 2. The exposing region 40a and exposing region 40b may be arranged such that they have spacing in the scanning direction, or they overlap with each other by adjusting the placement of the DMDs 34a, 34b, and configuration of the first and second projector lenses 36, 38. Further, the exposing region 40a and exposing region 40b may be arranged such that they partially overlap with each other by displacing the exposing region 40a and exposing region 40b in the scanning direction.

Further, in the first embodiment, DMD 34a and DMD 34b may be attached to the exposing head 30 such that the arranging direction of the micro-mirrors 58a, 58b thereof forms a predetermined tilt angle θ with the scanning direction.

Still further, in the first embodiment, if the exposed regions 41 exposed by the respective exposing heads 30 are formed with a space between them in the arranging direction of the exposing heads 30, a plurality of exposing head 30 arrays may be disposed in the scanning direction so that the space between the exposed regions 41 exposed by the exposing head 30 array disposed in downstream of the scanning direction is exposed by the exposing head 30 array disposed in upstream of the scanning direction. Preferably, the exposed regions 41 exposed by the exposing head 30 array disposed in downstream and those exposed by the exposing head 30 array disposed in upstream partially overlap with each other in this case.

Further, in the first embodiment, the exposing region 40a and exposing region 40b are arranged side by side in the scanning direction as shown in FIG. 2. But, they may be arranged in a direction which is orthogonal to the scanning direction.

Next, a photolithography machine that employs a second embodiment of the tracing method and apparatus of the present invention will be described. The configuration of the photolithography machine of the present embodiment is similar to that of the first embodiment. It only differs from the first embodiment in the drive control method for drive controlling the DMDs 34a, 34b in each of the exposing heads 30. Accordingly, only the drive controlling method will be described herein below.

In the first embodiment, resetting of the DMDs 34a, 34b is implemented after the control signals are transferred to all of the blocks A to D of the DMDs 34a, 34b. Such control method requires an extended time for transferring the control signals to all of the blocks A to D.

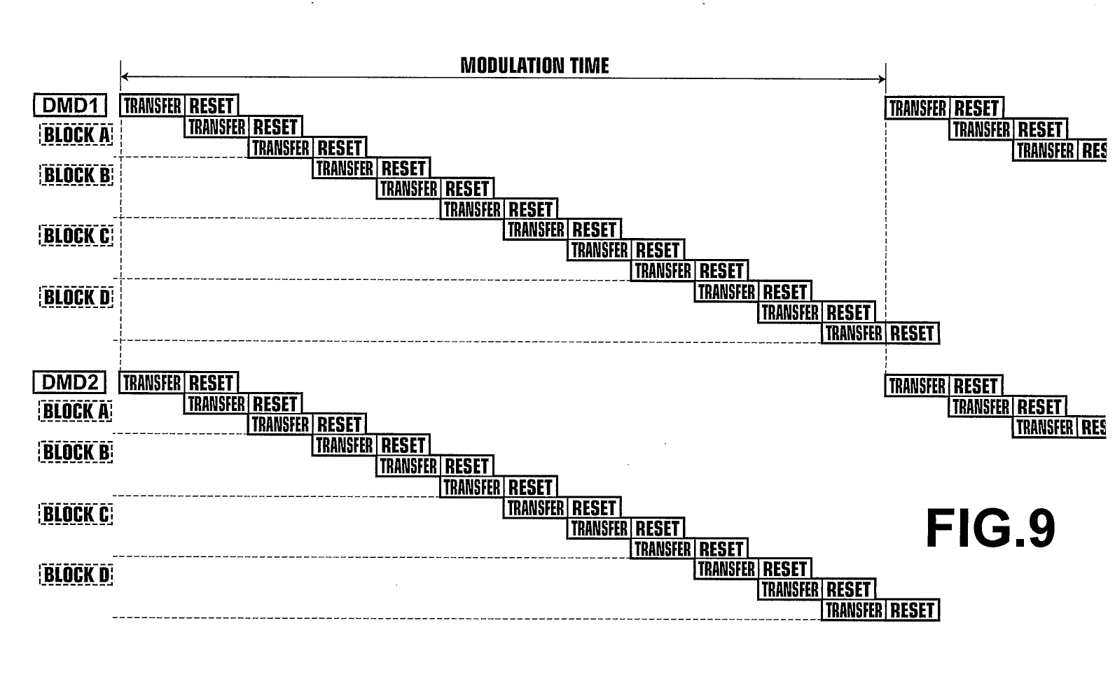

In the second embodiment, therefore, the resetting is implemented by transferring the control signals at the timings shown in FIG. 9. More specifically, the control signals for DMDs 34a, 34b are transferred first to each of the blocks A to D in this order as in the first embodiment. Then, in each of the blocks A to D in each of the DMDs 34a, 34b, the control signals are transferred sequentially to each of the segments 1 to 3, and the micro-mirrors 58 in each of the segments 1 to 3 are sequentially reset by the voltage control section 66 from the time when each of the transfers of the control signals to each of the segments is completed as shown in FIG. 9. By implementing the drive control in the manner as described above, the modulation time may be reduced by the resetting time.

Next, a photolithography machine that employs a third embodiment of the tracing method and apparatus of the present invention will be described. The configuration of the photolithography machine of the present embodiment is also similar to that of the first embodiment. It only differs from the first embodiment in the drive control method for drive controlling the DMDs 34a, 34b in each of the exposing heads 30. Accordingly, only the drive controlling method will be described herein below.

In the first embodiment, the control signals of the blocks A to D of the DMDs 34a, 34b are transferred sequentially to the block A to block D. Such control method requires an extended time for transferring the control signals to all of the blocks A to D.

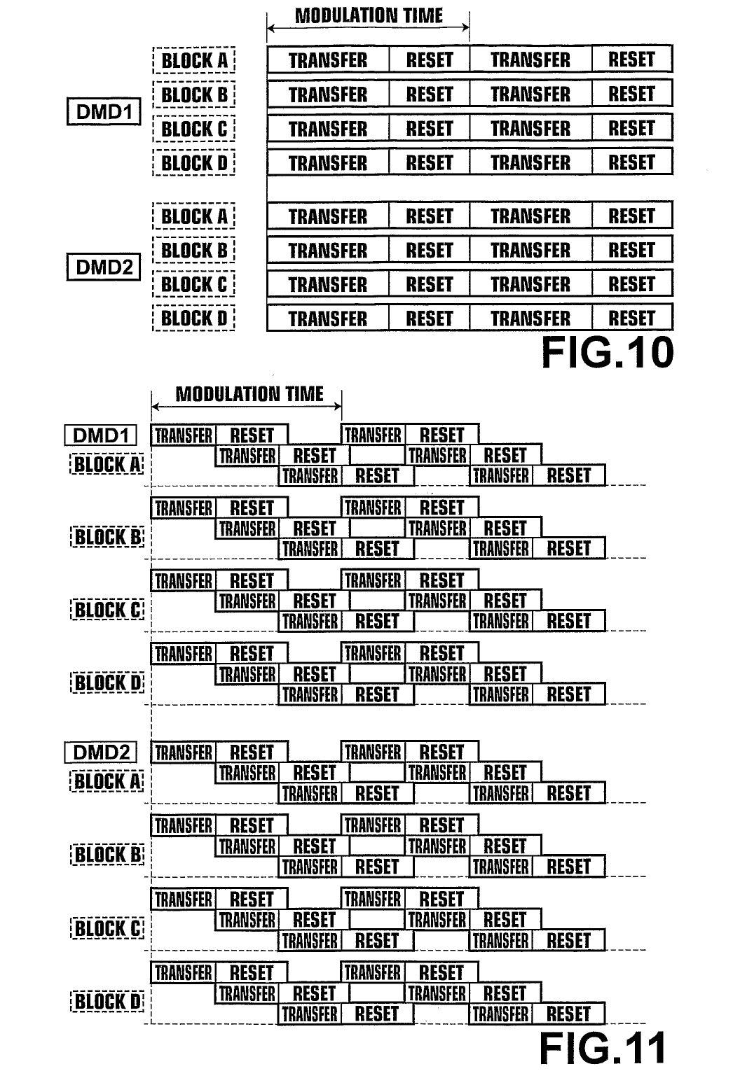

In the third embodiment, therefore, the resetting is implemented by transferring the control signals at the timings shown in FIG. 10. More specifically, in each of the DMDs 34a, 34b, the control signals are transferred to each of the blocks A to D in parallel by the control signal transfer sections 60A to 60D provided for each of the blocks A to D. As shown in FIG. 10, when the transfer of the control signals to all of the blocks A to D is completed, all of the micro-mirrors 58 of the DMDs 34a, 34b are reset by the voltage control section 66. By implementing the drive control in the manner as described above, the time required for transferring the control signals may be reduced, thereby the modulation time may be reduced.

Next, a photolithography machine that employs a fourth embodiment of the tracing method and apparatus of the present invention will be described. The fourth embodiment is something like an embodiment that combines drive control methods of the second and third embodiments.

In the fourth embodiment, the resetting is implemented by transferring the control signals at the timings shown in FIG. 11. More specifically, in each of the DMDs 34a, 34b, control signals are transferred to each of the blocks A to D in parallel by the control signal transfer sections 60A to 60D provided for each of the blocks A to D as in the third embodiment. Then, as in the second embodiment, in each of the blocks A to D in each of the DMDs 34a, 34b, the control signals are transferred sequentially to each of the segments 1 to 3, and the micro-mirrors 58 in each of the segments 1 to 3 are sequentially reset by the voltage control section 66 from the time when each of the transfers of the control signals to each of the segments is completed as shown in FIG. 11. By implementing the drive control in the manner as described above, the modulation time may be further reduced by the resetting time compared with the third embodiment.

Next, a photolithography machine that employs a fifth embodiment of the tracing method and apparatus of the present invention will be described. The fifth embodiment is similar to the third embodiment. It differs from the third embodiment only in the drive control method, that is, modulation timing of each of the blocks A to D in each of the DMDs 34a, 34b is different from the third embodiment.

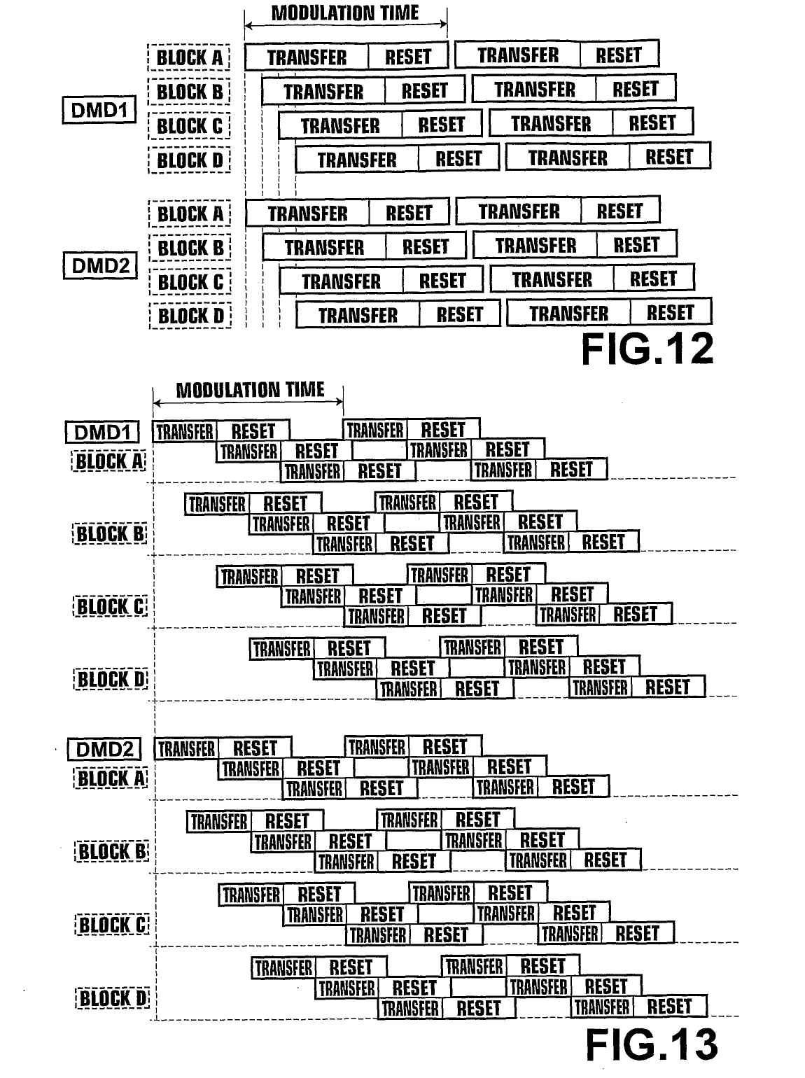

More specifically, in each of the DMDs 34a, 34b, the modulation timing of each of the blocks A to D is sequentially delayed by a predetermined time by sequentially delaying the start timing of transferring the control signals to each of the blocks A to D by the predetermined time in each of the DMDs 34a, 34b as shown in FIG. 12. By sequentially delaying the modulation timing of each of the blocks A to D as described above, trace points may be exposed with higher resolution in the scanning direction. In addition, the space between the trace points of each of the segments 1 to 3 may be controlled. For example, the trace points of each of the segments 1 to 3 may be arranged evenly spaced apart.

Next, a photolithography machine that employs a sixth embodiment of the tracing method and apparatus of the present invention will be described. The sixth embodiment is something like an embodiment that combines drive control methods of the fourth and fifth embodiments.

More specifically, as shown in FIG. 13, in each of the blocks A to D in each of the DMDs 34a, 34b, the control signals are transferred sequentially to each of the segments 1 to 3, and the micro-mirrors 58 in each of the segments 1 to 3 are sequentially reset by the voltage control section 66 from the time when the each of the transfers of the control signals to each of the segments is completed, and the modulation timing of each of the blocks A to D is sequentially delayed by a predetermined time by sequentially delaying the start timing of transferring the control signals to each of the blocks A to D by the predetermined time as in the fourth embodiment. By implementing the drive control in the manner as described above, trace points with higher resolution may be obtained in the scanning direction. In addition, the space between the trace points of each of the segments 1 to 3 may be controlled. For example, the trace points of each of the segments 1 to 3 may be arranged evenly spaced apart.

In the first to sixth embodiments, the transfer of the control signals and resetting are controlled at the same timings for the DMD 34a and DMD 34b. But, they may be controlled at different timings between the DMD 34a and DMD 34b.

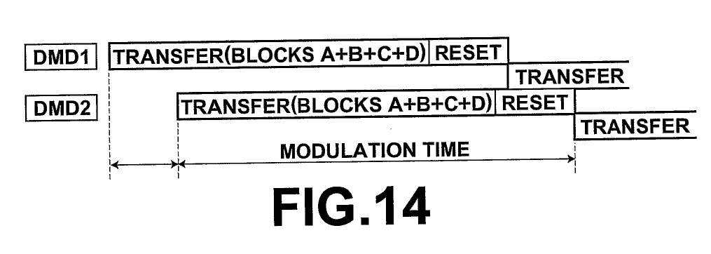

For example, in the first embodiment, the modulation timing of the DMD 34b may be delayed from that of the DMD 34a by delaying the start timing of transferring the control signals to the DMD 34b from that of the DMD 34a by a predetermined time as shown in FIG. 14. By implementing the drive control in the manner as described above, trace points with higher resolution may be obtained compared with the first embodiment.

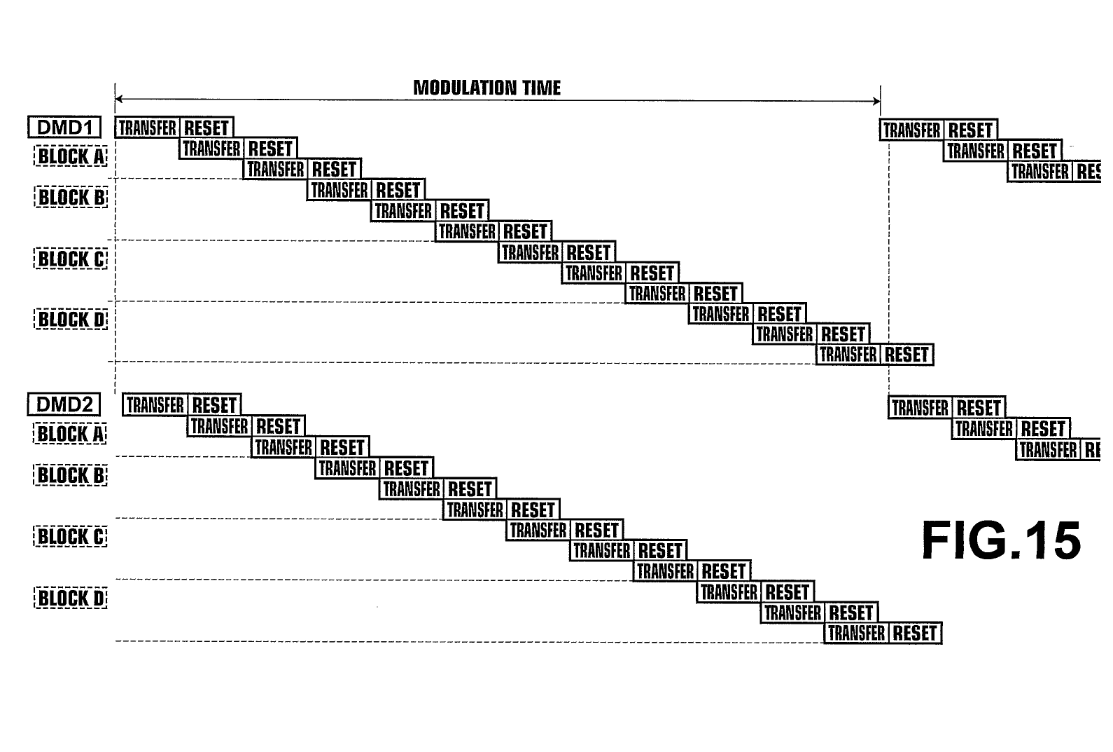

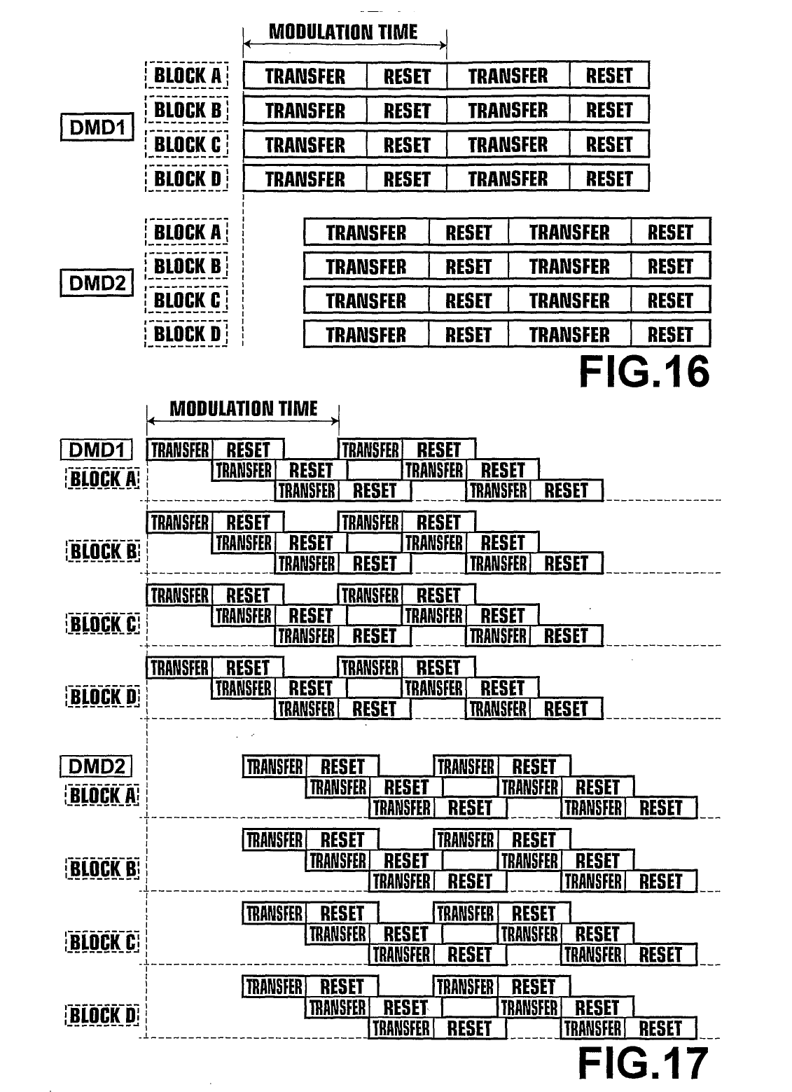

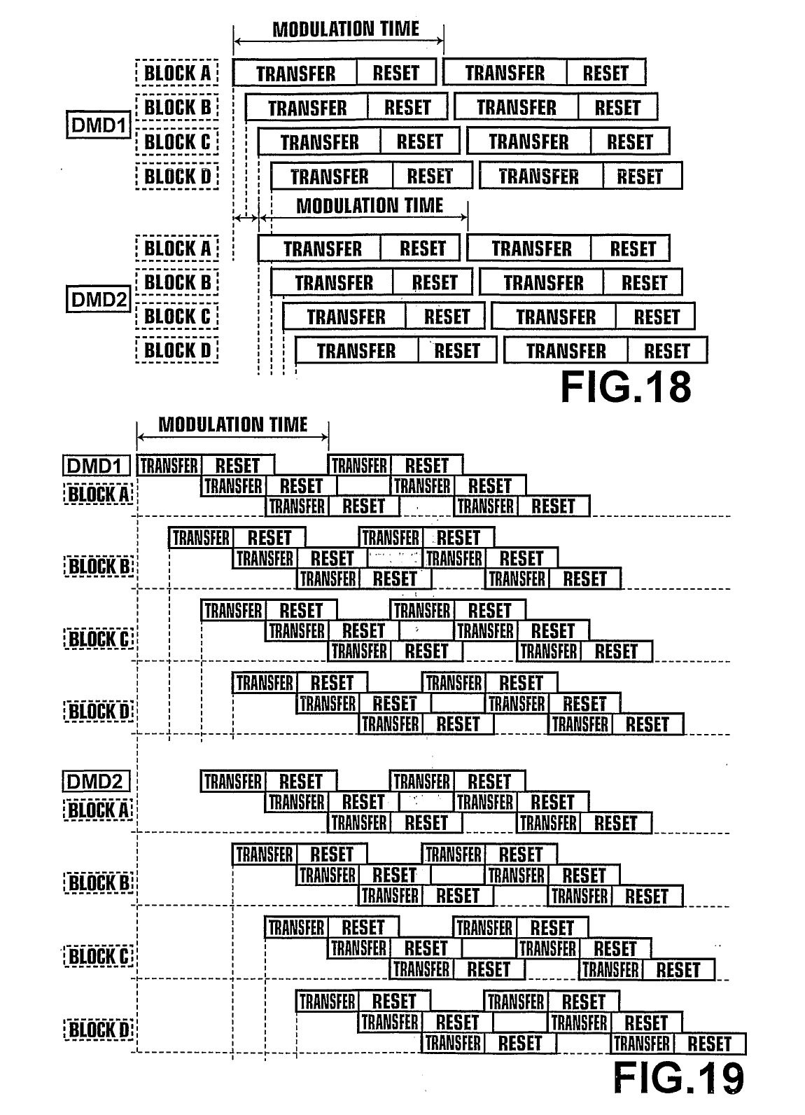

The timing chart for the case where each of the DMDs 34a, 34b is drive controlled at different timings in the manner as described above in the second embodiment is shown in FIG. 15. Likewise, the time charts for the case where each of the DMDs 34a, 34b is drive controlled at different timings in the third embodiment, fourth embodiment, fifth embodiment and sixth embodiment are shown in FIGS. 16, 17, 18 and 19 respectively.

By drive controlling the DMD 34a and DMD 34b at the timings shown in FIGS. 15 to 19, trace points with higher resolution may be obtained.

In the embodiments described above, the trace region corresponding to the DMD 34a, and the trace region corresponding to the DMD 34b may be arranged to overlap with each other, or the trace point of the trace region corresponding to the DMD 34b may be arranged between the trace points of the trace region corresponding to the DMD 34a by controlling, for example, the modulation timing of each of the DMDs 34a, 34b, and the moving speed of the moving stage 14.

Further, each of the trace regions corresponding to each of the blocks A to D in each of the DMDs 34a, 34b may be arranged to overlap with each other, or, for example, the trace points of the trace regions corresponding to the blocks B to D may be arranged between the trace points of the trace region corresponding to the block A by controlling the timing of the modulation in each of the blocks A to D in each of the DMDs 34a, 34b, and the moving speed of the moving stage 14.

Still Further, each of segment trace regions corresponding to each of the segments 1 to 3 in each of the blocks A to D may be arranged to overlap with each other, or, for example, the trace points of the segment trace regions corresponding to the segments 2 and 3 may be arranged between the trace points of the segment trace region corresponding to the segment 1 by controlling the timing of the modulation in each of the segments 1 to 3 in each of the blocks A to D, and the moving speed of the moving stage 14.

That is, the modulation timing of the DMD driving unit (e.g., entire region of one DMD, block, or segment) of one of the exposing heads 30, and the moving speed of the moving stage 14 may be controlled such that images of at least two DMD driving units overlap with each other, or such that each of the trace points of the image of one DMD driving unit is arranged between the trace points of the image of another DMD driving unit.

Further, in the embodiments described above, it is preferable that the exposure is implemented first by the DMD 34a disposed downstream in the scanning direction, then by the DMD 34b disposed upstream in the scanning direction.

Still further, in each of the DMDs 34a, 34b, it is preferable that the exposure is implemented first by the block disposed downstream in the scanning direction, then by the block disposed upstream in the scanning direction.

Further, in each of the DMDs 34a, 34b, it is preferable that the exposure is implemented first by the segment in the block disposed downstream in the scanning direction, then by the segment in the block disposed upstream in the scanning direction.

Still further, it is preferable that the modulation timing of each of the DMDs 34a, 34b, and the moving speed in the scanning direction are controlled such that trace points of each of the trace regions corresponding to each of the DMDs 34a, 34b are arranged evenly spaced apart in the scanning direction.

Further, in each of the DMDs 34a, 34b, it is preferable that the modulation timing of each of the blocks, and the moving speed in the scanning direction are controlled such that trace points of each of the trace regions corresponding to each of the blocks are arranged evenly spaced apart in the scanning direction.

Still further, in each of the DMDs 34a, 34b, it is preferable that the modulation timing of each of the segments in each of the blocks, and the moving speed in the scanning direction are controlled such that trace points of each of the segment trace regions corresponding to each of the segments in each of the blocks are arranged evenly spaced apart in the scanning direction.

Further, it is preferable that the number of segments designated by N in each of the blocks in each of the DMDs 34a, 34b satisfies the following formula.
N=Tₛᵣ/Tₜᵣ
where:
   Tₜᵣ: modulation time of each segment
   Tₛᵣ: transfer time of control signals to each segment

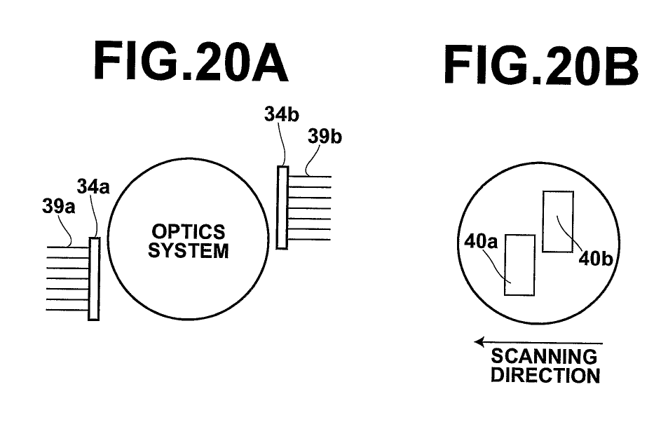

Still further, in the embodiments described above, the DMD 34a and DMD 34b are aligned in a line which is orthogonal to the scanning direction. But, as shown in FIG. 20A, they may be displaced in opposite directions with each other by a predetermined distance from the line which is orthogonal to the scanning direction. FIG. 20A is a plan view of the exposing head 30, and FIG. 20B is a drawing illustrating the exposing regions 40a and 40b on the exposing surface when DMDs 34a, 34b are arranged in the manner as illustrated in FIG. 20A. The arrangement method of a plurality of DMDs is not limited to those described above. They may be arranged in the scanning direction or in a direction which is orthogonal to the scanning direction by other possible methods.

Further, in the embodiments described above, each of the DMDs 34a, 34b is divided into the plurality of blocks A to D in the scanning direction. But, the division method of each of the DMDs 34a, 34b is not limited to the scanning direction. It may be, for example, divided into a plurality of blocks in a direction orthogonal to the scanning direction, and the control signals may be transferred to each of the blocks in parallel or independently. In addition, each of the blocks provided in the manner as described above may be further subdivided into segments in the scanning direction, or a direction orthogonal to the scanning direction, and the transfer of the control signals and modulation may be implemented on a segment by segment basis as in the embodiments described above. The DMD arrangement described above may allow a faster modulation speed.

By providing at least two parallel or independent transfer units (DMDs, blocks or segments, or combination thereof) in a single exposing head 30 as described above, a rapid modulation may be realized.

Further, by controlling the timing of the modulation on the basis of at least two parallel or independent transfer units described above, intended dot arrangement may be realized on the exposing surface. Here, the stage moving speed of the moving stage 14 is determined first at an intended speed, then the modulation timing on the basis of the parallel or independent transfer units may be controlled or set according to the predetermined stage moving speed. Alternatively, the modulation timing on the basis of the parallel or independent transfer units is determined first at an intended value, then the moving speed of the moving stage 14 may be controlled according to the predetermined modulation timing.

Still further, in the embodiment in which lower-level parallel or independent transfer units are provided in upper-level parallel or independent transfer units like the case, for example, where the segments are provided in the blocks, the modulation timing of the lower-level parallel or independent transfer units may be directly controlled or set. Alternatively, the modulation timing of the lower-level parallel or independent transfer units may be controlled or set through control of the upper-level parallel or independent transfer units.

In the embodiments described above, the photolithography machine that includes DMDs as the spatial optical modulation device has been illustrated. A transmissive spatial optical modulation device may also be used beside such reflective spatial optical modulation device.

Further, the shape of the DMD is not limited to rectangle, and the micro-mirrors may be arranged in parallelogram or other shapes, and such DMDs may also be used in the present invention.

In the embodiments described above, the photosensitive material 12, which is the object of exposure, may be a printed board or a display filter. Further, the photosensitive material 12 may be of sheet-like form or continuous length (such as flexible substrate or the like).

Further, in the embodiments described above, a so-called flatbed photolithography machine has been illustrated. But, the present invention may also be applied to a so-called outer drum photolithography machine having a drum on which the photosensitive material is rolled.

The tracing method and apparatus of the present invention may also be applied to trace control of an ink-jet printer or the like. For example, the trace points through jetting of ink may be controlled in the similar manner as described in the present invention. That is, the tracing elements of the present invention may be replaced by the elements that provide trace points through jetting of ink or the like.

1-20. (canceled)

21. A tracing method using a tracing head that includes a spatial optical modulation device constituted by multitudes of tracing elements disposed thereon two-dimensionally for modulating inputted light according to control signals transferred in accordance with tracing information, and an optics system for focusing the light modulated by the spatial optical modulation device on a tracing surface, in which tracing is performed by implementing the modulation through transferring the control signals to the tracing elements of the spatial optical modulation device, and moving the tracing head in a predetermined scanning direction relative to the tracing surface, wherein:
the tracing head includes a plurality of the spatial optical modulation devices and a common optics system for focusing the light modulated by the plurality of spatial optical modulation devices on the tracing surface; and
the method uses the tracing head that includes the plurality of spatial optical modulation devices and the common optics system to perform the tracing.

22. The tracing method according to claim 21, wherein the plurality of spatial optical modulation devices and the optics system of the tracing head are disposed such that the regions of the tracing surface on which the light modulated by the plurality of spatial optical modulation devices is focused by the optics system are arranged side by side in the scanning direction and/or a direction which is orthogonal to the scanning direction.

23. The tracing method according to claim 21, wherein the control signals are transferred to the plurality of spatial optical modulation devices in parallel or independently.

24. The tracing method according to claim 23, wherein the arrangement of each of trace regions on the tracing surface corresponding to each of the spatial optical modulation devices is controlled by causing the modulation to be implemented independently by each of the spatial optical modulation devices, and controlling the timing of the modulation implemented independently by each of the spatial optical modulation devices, and/or the relative moving speed of the tracing head in the scanning direction.

25. The tracing method according to claim 21, wherein:
each of the plurality of spatial optical modulation devices is divided into a plurality of blocks, and
the control signals are transferred to each of the plurality of blocks in each of the spatial optical modulation devices in parallel or independently.

26. The tracing method according to claim 25, wherein:
each of the blocks in each of the spatial optical modulation devices is further subdivide into a plurality of segments, and
the control signals are transferred sequentially to each of the plurality of segments, and the modulation is implemented sequentially when each of the transfers of the control signals is completed in each of the blocks in each of the spatial optical modulation devices.

27. The tracing method according to claim 21, wherein:
each of the plurality of spatial optical modulation devices is divided into a plurality of blocks in the scanning direction; and
the control signals are transferred to each of the blocks in each of the spatial optical modulation devices in parallel or independently.

28. The tracing method according to claim 27, wherein the arrangement of each of block trace regions on the tracing surface corresponding to each of the blocks in each of the spatial optical modulation devices is controlled by causing the modulation to be implemented independently by each of the blocks in each of the spatial optical modulation devices, and controlling the timing of the modulation implemented independently by each of the blocks in each of the spatial optical modulation devices, and/or the relative moving speed of the tracing head in the scanning direction.

29. The tracing method according to claim 27, wherein:
each of the blocks in each of the spatial optical modulation devices is further subdivided into a plurality of segments in the scanning direction; and
the control signals are transferred sequentially to each of the plurality of segments, and the modulation is implemented sequentially when each of the transfers of the control signals is completed in each of the blocks in each of the spatial optical modulation devices.

30. The tracing method according to claim 29, wherein the arrangement of each of segment trace regions on the tracing surface corresponding to each of the segments in each of the blocks in each of the spatial optical modulation devices is controlled by controlling the timing of the modulation implemented by each of the segments in each of the blocks in each of the spatial optical modulation devices, and/or the relative moving speed of the tracing head in the scanning direction.

31. A tracing apparatus comprising:
a tracing head including a spatial optical modulation device constituted by multitudes of tracing elements disposed thereon two-dimensionally for modulating inputted light according to control signals transferred in accordance with tracing information, and an optics system for focusing the light modulated by the spatial optical modulation device on a tracing surface;
a moving means for moving the tracing head in a predetermined scanning direction relative to the tracing surface; and
a control means for causing the tracing elements of the spatial optical modulation device to implement the modulation by transferring the control signals thereto, and controlling the relative moving speed of the tracing head in the scanning direction through controlling the moving means,
wherein the tracing head includes a plurality of the spatial optical modulation devices and a common optics system for focusing the light modulated by the plurality of spatial optical modulation devices on the tracing surface.

32. The tracing apparatus according to claim 31, wherein the plurality of spatial optical modulation devices and the optics system of the tracing head are disposed such that the regions of the tracing surface on which the light modulated by the plurality of spatial optical modulation devices is focused by the optics system are arranged side by side in the scanning direction and/or a direction which is orthogonal to the scanning direction.

33. The tracing apparatus according to claim 31, wherein the control means includes a plurality of control signal transfer sections, each being provided for each of the plurality of spatial optical modulation devices, for transferring the control signals to the plurality of spatial optical modulation devices in parallel or independently.

34. The tracing apparatus according to claim 33, wherein the control means is configured to control the arrangement of each of trace regions on the tracing surface corresponding to each of the spatial optical modulation devices by causing the modulation to be implemented independently by each of the spatial optical modulation devices, and controlling the timing of the modulation implemented independently by each of the spatial optical modulation devices, and/or the relative moving speed of the tracing head in the scanning direction.

35. The tracing apparatus according to claim 31, wherein:
each of the plurality of spatial optical modulation devices is divided into a plurality of blocks, and
the control means includes a plurality of block control signal transfer sections, each being provided for each of the plurality of blocks in each of the spatial optical modulation devices, for transferring the control signals to each of the blocks in each of the spatial optical modulation devices in parallel or independently.

36. The tracing apparatus according to claim 35, wherein:
each of the blocks in each of the spatial optical modulation devices is further subdivide into a plurality of segments, and
the control means is configured to sequentially transfer the control signals to each of the segments and to cause the modulation to be implemented sequentially when each of the transfers of the control signals is completed in each of the blocks in each of the spatial optical modulation devices.

37. The tracing apparatus according to claim 31, wherein:
each of the plurality of spatial optical modulation devices is divided into a plurality of blocks in the scanning direction, and
the control means includes a plurality of block control signal transfer sections, each being provided for each of the blocks in each of the spatial optical modulation devices, for transferring the control signals to each of the blocks in each of the spatial optical modulation devices in parallel or independently.

38. The tracing apparatus according to claim 37, wherein:
the control means is configured to control the arrangement of each of block trace regions on the tracing surface corresponding to each of the blocks in each of the spatial optical modulation devices by causing the modulation to be implemented independently by each of the blocks in each of the spatial optical modulation devices, and controlling the timing of the modulation implemented independently by each of the blocks in each of the spatial optical modulation devices, and/or the relative moving speed of the tracing head in the scanning direction.

39. The tracing apparatus according to claim 37, wherein:
each of the blocks in each of the spatial optical modulation devices is further subdivided into a plurality of segments in the scanning direction, and
the control means is configured to sequentially transfer the control signals to each of the segments and to cause the modulation to be implemented sequentially when each of the transfers of the control signals is completed in each of the blocks in each of the spatial optical modulation devices.

40. The tracing apparatus according to claim 39, wherein the control means is configured to control the arrangement of each of segment trace regions on the tracing surface corresponding to each of the segments in each of the blocks in each of the spatial optical modulation devices by controlling the timing of the modulation implemented by each of the segments in each of the blocks in each of the spatial optical modulation devices, and/or the relative moving speed of the tracing head in the scanning direction.
